(19) United States
(12) Patent Application Publication
(10) Pub. No.: US 2022/0325897 A1
(43) Pub. Date: Oct. 13, 2022

(54) METHOD AND SYSTEM FOR A HEAT SUPPLY TO A PRODUCT TO BE COOKED

(71) Applicant: Vorwerk & Co. Interholding GmbH, Wuppertal (DE)

(72) Inventors: Robert Frielinghaus, Bochum (DE); Matthias Stein, Mulheim an der Ruhr (DE)

(21) Appl. No.: 17/714,972

(22) Filed: Apr. 6, 2022

(30) Foreign Application Priority Data
Apr. 8, 2021 (EP) 21167403.1

(51) Int. Cl. F24C 7/08; F24C 15/00

(52) U.S. Cl. CPC F24C 7/087; F24C 7/085; F24C 15/00

(57) ABSTRACT

A method for preparing a food or a beverage includes inserting a food thermometer into a product to be cooked and transmitting temperatures measured by the food thermometer to a control device.

### CROSS-REFERENCE TO RELATED APPLICATION

This application claims benefit of priority to European Patent Application No. 21167403 filed, Apr. 8, 2021, the disclosure of which is hereby incorporated in its entirety by reference herein.

### TECHNICAL FIELD

The disclosure relates to a method and a system for supplying heat to a product to be cooked for preparing a food or a beverage.

### BACKGROUND

During the heating of food or beverage using conventional methods detailed temperature information is unavailable. In particular, conventional methods require a user to take frequent action during heating to control the flow of heat. However, such methodology makes achieving a precise food preparation or readiness result difficult or impossible.

### SUMMARY

According to the method, a food thermometer with two temperature sensors is inserted into a product to be cooked in such a way that one temperature sensor is located inside the product to be cooked and one temperature sensor is located outside the product to be cooked. This makes it possible to measure the temperature inside the product to be cooked and the outside temperature prevailing in the immediate surroundings of the product to be cooked. Actual temperatures are therefore measured.

### BRIEF DESCRIPTION OF DRAWINGS

FIG. 1 illustrates an example food processor;

FIG. 2 illustrates an example food thermometer;

FIG. 3 illustrates an example use of the food thermometer; and

FIG. 4 illustrates an example curve of temperature in an oven.

### DETAILED DESCRIPTION

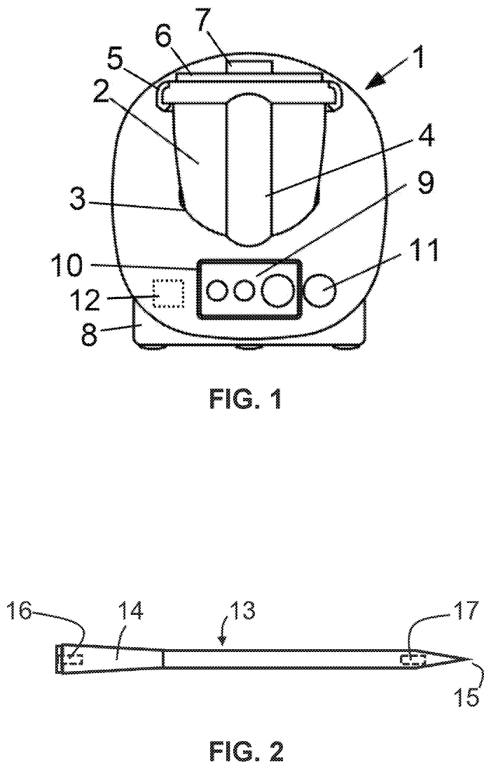

FIG. 1 shows a food processor 1. The food processor 1 comprises a food preparation vessel 2, which is inserted into a holder 3 of the food processor 1. The food preparation vessel 2 comprises a handle 4 for easily removing the food preparation vessel 2 from the holder 3. The food processor 1 may comprise a closing mechanism having, for example, pivotally mounted arms 5. In the closed position shown in FIG. 1, the arms 5 enclose a lid 6. As a result, the lid 6 is then fixedly connected to the food preparation vessel 2. The lid 6 may comprise an opening into which a vessel 7, which may be transparent, can be inserted. The vessel 7 can be used to close the opening in the lid 6. The vessel 7 can be lifted off the opening at any time, so that an opening is then provided through which an ingredient can be filled into the food preparation vessel 2. The vessel 7 can serve as a dosing aid. If the optionally provided closing mechanism is opened, then the lid 6 can be removed from the food preparation vessel 2. The food processor 1 comprises a stand part 8 for setting up. The stand part can be connected to an external power source, for example, via a power cable. However, the stand part may also comprise a rechargeable battery for its power supply.

A user interface 9 is shown on a display 10. The display 10 is preferably touch-sensitive, for example to allow operating parameters to be set by touching the display. The display 10 serves as an input device and output device. The food processor 1 can comprise as an additional input device, for example, a rotary and/or push button 11, which may also serve for setting one or more operating parameters in interaction with the user interface 9. For example, if the user interface 9 requests a confirmation, for example, for the user to perform a cooking step, the confirmation can be entered by pressing the rotary and/or push button 11. For example, if the user interface 9 relates to a mixing and cutting device of the food processor 1, a rotational speed can be set by rotating the rotary and/or push button 11. By rotating the rotary and/or push button 11, time durations for certain food preparation processes and/or temperatures may also be set, for example.

The food processor 1 comprises a schematically shown control device 12, which can, for example, access a recipe stored digitally in an external memory unit or in the food processor and can be caused by a recipe step of the recipe to operate the functional components of the food processor 1 and of further kitchen appliances as defined in a recipe step of the recipe. The control device 12 is connected to a wireless transmitting and/or receiving unit for establishing respective data connections to a food thermometer, a computer, a mobile phone and/or at least one further kitchen appliance. Furthermore, the control device 12 may be configured to optimize the digital recipe for a food preparation process or to create a digital recipe for a food preparation process and to store a created digital recipe in the external memory unit or in a memory unit of the food processor 1. At the same time, the control device 12 may comprise the memory unit.

The food preparation vessel 2 comprises in its base a mixing tool not shown, the shaft of which extends through the bottom of the food preparation vessel 2. The shaft is driven by an electric motor located in the stand part 8. The shaft of the mixing tool may be connected to the shaft of the electric motor by a releasable coupling.

FIG. 2 shows a food thermometer 13. The housing of the food thermometer 13 consists of metal with the exception of a handle 14. The handle 14 is located at one end of the food thermometer 13. The handle 14 consists of a heat insulating material such as plastic. For example, the handle 14 consists of an elastomer. The end of the food thermometer 13 opposite the handle 14 is formed by a tip 15. The food thermometer 13 has two temperature sensors 16 and 17. One temperature sensor 17 is located at the tip 15. The other temperature sensor 16 is located at the handle 14 and is adjacent to the end face of the elongated food thermometer 13. As shown, the end face may be designed eraser-like (similar to a pencil with an eraser attached to the end face) in order to be able to achieve good heat exchange. In this way, the temperature sensor 16 is arranged such that it is not thermally shielded in an undesirable manner by the thermally insulating handle 14.

The cross-section of the food thermometer 13 can be round in order to be particularly easy to clean.

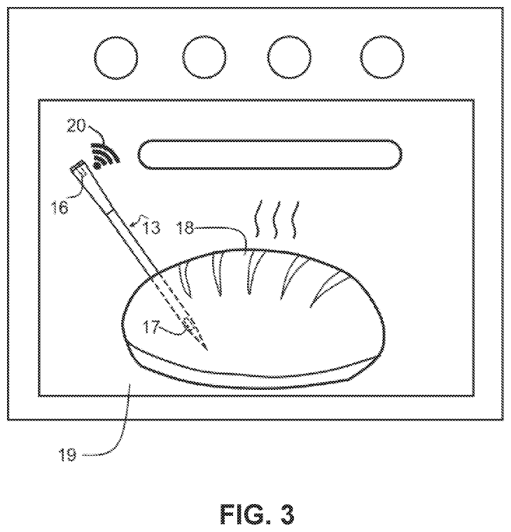

FIG. 3 shows a bread dough 18 which is located in an oven 19. The food thermometer 13 has been inserted with its tip into the bread dough 18. As a result, the temperature sensor 17 present at the tip is located in the bread dough 18. The temperature sensor 16 located at the handle is located outside the bread dough 18, but inside the oven 19. Via a wireless transmitting and receiving device 20, the measured actual temperatures are wirelessly transmitted to the control device 12 of the food processor 1. The control device 12 compares the actual temperatures measured by the food thermometer 13 with desired temperatures stored in the memory unit for baking the bread dough 18. If the control device 12 determines, for example, that a transmitted actual temperature of the temperature sensor 16, which measures the temperature prevailing in the oven, deviates significantly from a stored desired temperature, the food processor 1 informs via the display 10 that the oven temperature should be changed. The user can be additionally made aware of the need for action by an acoustic signal of the food processor.

Significant deviation means that such a large temperature deviation has been detected by the control and memory unit that a threshold value stored in the memory unit has been exceeded.

If the control device 12 determines, for example, that a transmitted actual temperature of the temperature sensor 17, which measures the temperature prevailing in the bread dough, has reached a stored desired temperature, the food processor 1 informs via the display 10, for example, that the oven temperature should be increased in order to finally optimize a crust of the bread dough. The user can be additionally made aware of the need for action by an acoustic signal of the food processor.

The thermometer 13 thus forms the basis of the disclosure. It is advantageously pencil-shaped as shown and has a thermocouple 17 in the tip 15 (which allows easy insertion into the product to be cooked) for measuring the internal or core temperature of the product to be cooked, as well as another thermocouple 16 in the “eraser part” for determining the surrounding temperature. This thermometer can be wirelessly coupled to the food processor 1 preferably via a Bluetooth connection, since there are correspondingly small distances to be covered in a kitchen and in order to minimize the power consumption for the food thermometer.

Before baking, for example, a proofing temperature that is too low, i.e. an actual temperature that is too low, may have been measured in the bread dough 18 in the context of a proofing process. In the form of an instruction for action, a user can then be prompted to bring the dough to an X° C. warm environment, wherein X° C. is a stored desired temperature.

After the bread dough has been brought into the oven 19 after the proofing process has been completed, the user can be informed about the baking time, for example by obtaining the information that the baking time will end in X minutes. X minutes is a stored desired time for the baking process. If it is determined by the control device 12 that the temperature prevailing in the oven 19 is too hot, the user may receive information via the display 10 that the oven is too hot and also the instruction for action that the temperature should be adjusted down by X° C. The indication X° C. is then a value calculated by the control device 12 by comparing the desired temperature and the actual temperature.

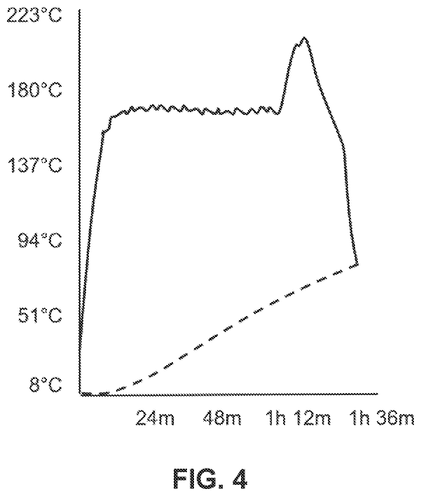

FIG. 4 shows an example of a temperature curve in an oven 19 with a bread dough 18 located therein, which has been realized by the disclosure. Plotted is temperature versus time. The solid line shows the temperature that has been measured by the temperature sensor 16 and, consequently, the temperature that has prevailed in the oven. The dashed line shows the temperature measured by the temperature sensor 17 and therefore the temperature prevailed in the dough.

First, the interior of the oven 19 was brought to a temperature of 170° C. Towards the end of the baking time, a temperature rise to a temperature of 220° C. was performed to obtain a crispy baked crust. The heat supply was then turned off. After the internal temperature of the oven had thus been cooled down to approximately 80° C., the user was informed via the display 10 that the bread could be removed from the oven.

By comparing the process control, in particular with a reference process, a guaranteed success can be achieved for previously uncontrollable steps outside the food processor 1.

The comparison of the temperature can be done by fixed algorithms, for example, a fixed set of rules, a fuzzy logic or artificial intelligence that can further adjust to the user's personal preferences over time.

Further full automation can be achieved through Smart-Home integration. Here, for example, the oven temperature can be readjusted via corresponding APIs.

In addition to hard temperature thresholds, the following are suitable for comparison of a desired/actual state
Temperature ramps;
Holding times at a certain temperature;
core and outside temperature differences.

The interaction and selection of the baking process are done through the display 10 of the food processor 1, Here, the user can select different programs that perform the above information and methods. The programs are food and process specific.

The system comprising the food processor 1 and the food thermometer 13 thus knows the behavior of the product to be cooked such as a steak on a grill or the behavior of baked goods in an oven. The system can control a user and manufacturing processes accordingly. For example, the system can inform the user of temperature curve and target temperatures, as well as an estimate of the run time of a cooking process. Further, the system can provide, for example, information about cooling-down behavior and when a product to be cooked, such as a baked good, is ready for consumption.

As part of a recipe development, actual temperatures for core and outside temperatures can be recorded during baking of a bread dough 18 and stored in a memory unit along with the information as desired temperatures. It is then also stored that the stored temperatures relate to producing the bread dough 18. This may be done by a user.

The disclosure also comprises a recipe development device comprising a computer program and a device for executing the computer program. The recipe development device can assist a user in a recipe development. For example, users generally do not know the target temperature or baking profile of baked goods.

The recipe development device may prompt a user to determine one or more target variables. A target variable may be a temperature or a temperature profile. Such a target variable can be suggested to a user by the recipe development device. By means of such a recipe development device, a recipe may also be created for inexperienced users. The recipe development device can be integrated in the food processor 1.

If a bread dough 18 is to be baked in the same way the next time, the stored desired temperatures are compared with the actual temperatures measured and transmitted to the control device, and recommendations in the form of instructions for action are transmitted to the user or executed directly.

Preparation according to the present disclosure comprises supplying heat to the product to be cooked by a heating device. This supply of heat may cause a product to be cooked to be brought to temperatures of, for example, at least 80° C. or at least 100° C. Temperatures of 350° C. can also be reached, for example for baking a pizza. Temperatures of more than 350° C. are generally not exceeded. The supply of heat can cause a product to be cooked to be heated only moderately or to be brought or maintained only to a temperature above room temperature. Thus, for example, the supply of heat can cause the product to be cooked to be brought to a temperature of, for example, 25° C. to 40° C. and/or a temperature between 25° C. to 40° C. to be kept constant.

According to the present disclosure, kitchen appliances with a heating device, such as an oven or pizza oven, microwave, steamer, hob with cooking vessel, food processor or grill, can be used to supply heat to a product to be cooked. However, the heating device can also be a radiator which is provided for heating a room and which is therefore not part of a kitchen appliance.

Examples of products to be cooked to which heat can be applied according to the disclosure are meat, vegetables, casseroles or dough for baked goods.

There are kitchen appliances, such as the food processor Thermomix®, that can measure and control the temperature in a food preparation vessel to suitably heat a product to be cooked for food preparation. From the publication EP 3 482 661 A1 a method and a system for adjusting a heating power of at least one heating element of a home appliance is known.

It is the task of the present disclosure to be able to prepare a food, the preparation of which requires a supply of heat, in an improved and flexible manner.

A food thermometer is a thermometer designed and suitable for measuring temperatures of a product to be cooked for preparing a food. The food thermometer can therefore measure temperatures that usually occur during the preparation of a food. Thus, it is not a thermometer that can and should measure very low temperatures of, for example, less than −50° C. or very high temperatures of, for example, more than 500° C. Preferably, the food thermometer can also measure temperatures such as may occur in a pizza oven, for example temperatures of up to 350° C. Preferably, the food thermometer can also measure temperatures that are at least above 20° C. The food thermometer generally has a tip so that the food thermometer can be inserted into a food without great effort. The food thermometer generally has an elongated shape so that two temperature sensors can be accommodated in the food thermometer with a suitable distance. A temperature can then be measured by each temperature sensor. The food thermometer is preferably designed so that it can be used in an oven at temperatures up to at least 200° C. and preferably also in a steamer. The food thermometer is a thermometer which is independent of any other kitchen appliance. It is therefore not a thermometer that is built into a kitchen appliance. The food thermometer is preferably battery operated. Thus, it can be supplied with electricity by a built-in battery. In particular, the battery is rechargeable.

The product to be cooked is usually supplied with heat by means of a heating device. The heating device can be a heating device of a kitchen appliance as described above. If the heating device is part of a kitchen appliance, it is in particular an electric heating device. The heating device may be an inductive stove. The heating device may be an electrical resistance heating device. The heating device can be a microwave generator. However, the heating device may also be a radiator for heating indoor spaces. For example, such a radiator may be heated by hot water which may flow through the radiator.

However, heat can also be supplied, for example, by a proofing process that takes place in the product to be cooked. It is only important that the temperature of the product to be cooked is changed and that this temperature change is measured by the thermometer.

The food thermometer transmits the one or more actual temperatures measured by its one or more temperature sensors to a control device. The transmission of actual temperatures can be performed wirelessly or by means of an electrical conductor. Thus, the food thermometer may comprise a wireless sending and receiving device. The control device may be part of a kitchen appliance. For example, the control device may be part of a food processor. However, the control device may also be an external device independent of a kitchen appliance. The control device may be part of a computer, which may be connected to a plurality of kitchen appliances such that the computer can exchange data with the kitchen appliances. The computer may be spatially separate from the location at which heat is supplied to the product to be cooked. For example, if heat is supplied to product to be cooked in a kitchen of a private household, the computer may be present outside the private household. The control device is an electronic device that may comprise, for example, an integrated circuit capable of performing computing operations.

A memory unit may be provided in which desired temperatures are stored or at least can be stored. Desired temperatures are temperatures that are to be reached. The memory unit is an electronic memory unit in which data can be stored electronically. The memory unit may be provided by an external device. The memory unit may be permanently physically connected to the control device. The memory unit may be part of a kitchen appliance. For example, the memory unit may be part of a food processor. In the memory unit, desired temperatures can be stored or are stored in particular in pairs depending on a product to be cooked, so that a desired temperature can be specified for each of the two different measured values. One or more temperature pairs are then stored in the memory unit and also information on which product to be cooked the temperature pairs relate to. Time profiles of desired temperatures or temperature pairs can be stored depending on a product to be cooked. The one desired temperature of a temperature pair and/or the one time profile of a desired temperature can then refer to the temperature that shall prevail in the immediate vicinity of the product to be cooked concerned. The other desired temperature of the temperature pair and/or the other time profile of the desired temperature can then refer to the temperature that is to prevail in the respective product to be cooked. Thus, a first desired temperature or a first desired temperature profile for the first temperature sensor and/or a second desired temperature or a second desired temperature profile for the second temperature sensor can be stored in the memory unit depending on the product to be cooked.

The memory unit may also comprise an integrated circuit through which data can be stored electronically.

The control device can control the heating device depending on the transmitted temperatures, i.e. depending on actual temperatures, by comparison with stored desired temperatures. For example, the heating device can be controlled by the control device in such a way that the interior of the product to be cooked and/or the surrounding temperature of the product to be cooked is brought to a respective stored desired temperature and/or is kept at the respective stored desired temperature. By the control device actual temperatures, i.e. the measured temperatures, can be controlled in a time-dependent manner. For example, the control device can be used to regulate the duration of a heat supply in order to control actual temperatures. Compared to the state of the art, an improved result is achieved because detailed temperature information is available and can be used for heat supply and, thus, for food preparation. It is thus possible to achieve a desired preparation result very precisely without the need for a user to take action during the heat supply.

Alternatively or additionally, the control device can transmit instructions for action to a user. This happens in particular when the control device registers a sufficiently large deviation of actual temperatures compared to desired temperatures stored in the memory unit. A sufficiently large deviation can be stored as a threshold value in the memory unit. Compared to the state of the art, again an improved result is achieved, because very detailed temperature information is available and can be used. In addition, the available heating devices can be freely selected, since it is not important that the control device can directly control the heat supply of a selected heating device.

Alternatively or additionally, the control device can create a preparation recipe depending on the actual temperatures transmitted. The control device can therefore detect actual temperatures or time-dependent actual temperature profiles measured during a heat supply to the product to be cooked and store them in the memory unit. Temperatures or temperature profiles stored in this way can be used for a subsequent preparation of a food as desired temperatures and/or desired temperature profiles, respectively, in order to be able to apply heat to the same product to be cooked in the same way. A user is thus able to heat a product to be cooked according to his own preferences and to store a heating operation that has once been carried out successfully or have it stored in an automated manner in such a way that this heating operation can be reproduced as part of a next food preparation operation in an automated manner or by means of instructions to the user. A user can thus adapt an existing recipe to his own preferences or create his own recipes. The recipe then comprises information on the product to be cooked and information on temperatures and/or temperature time curves.

The method can be performed very flexibly. It is therefore possible that a database with stored temperatures or temperature curves is provided outside a private household, which can then be accessed via the Internet. However, it is also possible that such a database is integrated into a kitchen appliance. The same applies to the control device, which can be part of a kitchen appliance, but can also be present outside a private household. The method is preferably performed in private households. The system according to the disclosure is preferably used in private households.

Since the thermometer is not a thermometer that is integrated into a kitchen appliance, it can be used flexibly. It is possible that a first kitchen appliance provides instructions for action for the control of temperatures that are measured in a second kitchen appliance by means of the thermometer. For example, the first kitchen appliance may be a food processor. The second kitchen appliance may be an oven. Due to the ability to transmit instructions for action to a user, any number of different second kitchen appliances can be used. Thus, it is not necessary that a first and a second kitchen appliance are configured such that they can exchange data with each other.

Preferably, a stored temperature profile is available that comprises a temperature rise at the beginning of a cooking time or at the end of a cooking time. By temperature rise at the beginning of a cooking time is meant that a relatively high temperature is set at the beginning, which is then lowered again. By temperature rise towards the end of a cooking time is meant that towards the end of a cooking time a relatively high temperature is set which was previously lower. Such a temperature rise is used for producing a crust and/or a browned surface, as may be desirable, for example, in the case of bread, meat or gratinated cheese. In the case of dough for baked goods, the temperature rise preferably occurs towards the end of the cooking time and/or towards the end of the baking time. In the case of meat, the temperature rise preferably occurs at the beginning of the cooking time.

An instruction for action to the user may be, for example, output graphically via a display and/or acoustically via a loudspeaker. The display may be a display of a kitchen appliance or a mobile phone. The loudspeaker may be a loudspeaker of a kitchen appliance or a mobile phone.

In one embodiment, it may be transmitted to the user as an instruction for action that the user shall set or change a distance between the product to be cooked and the heating device. For example, a bread dough with a food thermometer inserted therein may have been placed near a radiator so that, for example, yeast in the bread dough can become active in a suitable manner. It may be transmitted to the user as an instruction for action to change the distance between the bread dough and the radiator if no suitable surrounding temperature is measured by the temperature sensor of the food thermometer, which is located outside the bread dough. For example, if a bread dough with a food thermometer inserted therein is placed in an oven so that the bread dough can be baked, it may be transmitted to the user as an instruction for action to place the bread dough differently in the oven if no suitable surrounding temperature is measured. Alternatively or additionally, it may be transmitted to the user as an instruction for action to set the desired oven temperature of the oven differently.

Measuring a temperature inside the product to be cooked can be used to regulate the duration of the heat supply. Thus, when a provided internal temperature of the product to be cooked is reached, further heat supply can be stopped or the instruction for action can be transmitted to the user to turn off the heat supply. However, when a provided internal temperature of the product to be cooked is reached, a temperature rise can also be effected to produce a crust and/or a well-browned surface. The temperature rise may be caused by an instruction for action to the user or by direct control of the heating device by the control device. The example shows that a stored desired temperature profile need not be a temperature profile that depends on time. Instead, a desired temperature profile can depend, for example, on measured actual temperatures.

Stored desired temperatures as well as stored desired temperature profiles are preferably stored depending on dimensions of a product to be cooked. Weight of a product to be cooked, volume of a product to be cooked or thickness of a product to be cooked are dimensions in the sense of the disclosure. Thus, a stored desired temperature or a stored desired temperature profile may depend, for example, on whether a product to be cooked weighs 500 g or 1000 g or has a volume of 500 ml or 1000 ml. A stored desired temperature or a stored desired temperature profile may thus depend, for example, on whether product to be cooked is 2 cm or 4 cm thick.

Preferably, a food processor with integrated scale is used to determine the weight or volume of a product to be cooked. The weight or volume of a product to be cooked can be determined by means of the integrated scale. The volume can be determined by the food preparation vessel of the food processor in the case of a flowable product to be cooked, if the food preparation vessel has corresponding markings for different volumes. The food processor, for example the outside of the food preparation vessel, may have markings that can be used to determine the thickness of a product to be cooked. A dimension of a product to be cooked may also be determined using one or more other sensors or estimated by a user.

Depending on a determined dimension, the corresponding desired temperatures for the heat supply are then selected. This can be done in an automated manner, for example by a food processor, if the scale of the food processor, for example, is used to determine a dimension. However, a determined dimension can also be communicated to the system by a user via an input device. The system then selects the associated desired temperatures.

Preferably, a food processor comprises the control device, since a food processor can be used also in small kitchens due to a relatively small space requirement. A food processor in the sense of the disclosure is a kitchen appliance, which comprises a stand part and a food preparation vessel removable from the stand part for the preparation of a food. The control device is then located in the stand part. The food processor comprises a mixing tool for mixing and/or chopping ingredients of a food in the food preparation vessel. The mixing tool can be rotated at high speeds of several 1000 rpm, for example at least 8000 rpm, preferably at least 10,000 rpm. The rotational speed can be regulated. The stand part is dimensioned in such a way that the food processor can process ingredients of a food at said high rotational speeds without endangering the stability of the food processor. The volume of the food preparation vessel can be, for example, between 0.5 I and 3 I. A food processor in the sense of the present disclosure may comprise a heating device to be able to heat ingredients of a food in the food preparation vessel. A food processor according to the present disclosure may comprise a scale for weighing ingredients of a food in the food preparation vessel.

An input device may be provided by means of which it is possible to select how the control device processes transmitted actual temperatures. Thus, for example, it can be selected by means of the input device whether a heating device is to be controlled depending on transmitted actual temperatures or whether only instructions for action are to be issued to a user or whether actual temperatures are to be stored as desired temperatures for the creation of a preparation recipe. In one embodiment of the disclosure, it is also possible to select by means of the input device whether a heating device is to be controlled depending on transmitted temperatures and, in addition, instructions for action are to be issued to a user if required. The input device is in particular part of a food processor.

The disclosure is particularly advantageous for producing baked goods. A dough-products baking process is divided into 2 to 3 main steps (possibly proofing, baking, cooling down). All these steps have specific requirements for their surrounding temperature. The dough temperature, in turn, allows conclusions to be drawn as to whether the respective phase has been completed and/or is proceeding within the correct framework.

In a conventional baking process (temperature- and time-controlled), none of these phases runs in a truly controlled manner. An oven itself often has temperature deviations and inhomogeneities of more than ±10%. Even the use of a conventional food thermometer cannot solve such problems satisfactorily and also requires special knowledge and experience on the part of the user.

The disclosure makes it possible to produce baked goods in an improved manner without requiring special knowledge or experience on the part of the user. Even if a user himself has to become active due to instructions for action, this effort is minimized, since a user does not have to control continuously himself. The disclosure therefore relates in particular to the supply of heat to dough for the preparation of baked goods such as bread or rolls. In particular, heat is then supplied to the dough during baking in such a way that there is a temperature rise towards the end of the baking time. Preferably, after the end of the baking time, a cooling-down period is communicated to the user. The communication of a cooling-down period can, for example, be indicated graphically via a display. For example, a timer can be displayed that continuously indicates how long to wait to reach the end of the cooling-down period. The cooling-down period can be communicated to the user by an acoustic signal sounding after the end of the cooling-down period has been reached and/or by indicating that the end of the cooling-down period has been reached on a display.

Such a cooling-down period can be stored in the memory unit depending on the product to be cooked. Preferably, however, a desired temperature is stored for the product to be cooked. If this is reached by cooling down after completion of the baking process, the end of the cooling-down period is reached. The product to be cooked can then be used further. In the case of bread, for example, it can be eaten after the cooling-down period has elapsed.

Through the disclosure, the user can be accompanied throughout the entire baking process, for example by instructions already during dough preparation up to baking. The temperatures of the entire baking process (proofing, baking and cooling-down temperatures) can be monitored both inside the dough and in the environment. Based on this data, the user can, for example, decide for himself whether and how to react (manual mode) or receive a recommendation on how to react. The user can be notified about the end of baking, for example by an acoustic alarm signal. An acoustic alarm signal can prompt that a temperature in the oven needs to be readjusted (semi-automatic mode).

If the technical requirements are met, a reaction can be fully automatically. For example, a temperature in the oven can then be adjusted fully automatically. This makes it possible for even inexperienced users without any special prior knowledge to achieve perfect baking results. In addition, the user can actively influence the balance between predictability and good baking results: Instead of a rigid, plannable time specification with a sometimes unreliable result, he can opt for a dynamic baking time that informs him at least a few minutes prior to the end, but allows a perfect baking result.

The disclosure generally relates to a food thermometer with at least two temperature sensors. Unless the presence of two temperature sensors is expressly required, a food thermometer with only one temperature sensor is sufficient. More than two temperature sensors may also be present. If more than two temperature sensors are present, they may be distributed along the length of the food thermometer.

In principle, heat is always supplied to the product to be cooked in the course of preparation. However, there may also be cooling-down phases. Heat is then removed from the product to be cooked. In this case, the method according to the disclosure can be performed without supplying heat. Therefore, a heat supply is generally present. However, this need not always be the case.

1. A method for preparing a food or a beverage, the method comprising:
inserting a food thermometer including two temperature sensors into a product to be cooked, in such a way that one temperature sensor is located outside the product to be cooked and the other temperature sensor is located in the product to be cooked;
supplying heat to the product to be cooked, by means of a heating device, or cooling down the product to be cooked,
transmitting, by the food thermometer, actual temperatures measured with the one or more temperature sensors to a control device;
controlling, by the control device, the heating device depending on transmitted actual temperatures by comparison with desired temperatures stored in a memory unit; and/or
transmitting, by the control device, at least one instruction for action based on a comparison of at least one transmitted actual temperature with at least one desired temperature stored in a memory unit; and/or
storing, by the control device, at least one transmitted actual temperature in a memory unit as a desired temperature depending on a product to be cooked.

2. The method of claim 1, wherein a first desired temperature profile for the one temperature sensor and/or a second desired temperature profile for the other temperature sensor is stored in the memory unit depending on the product to be cooked.

3. The method of claim 1, wherein a temperature profile stored in the memory unit comprises a temperature rise towards the end of the cooking time.

4. The method of claim 1, wherein heat is supplied to a dough according to the temperature profile stored in the memory unit, which comprises a temperature rise towards the end of the cooking time.

5. The method of claim 1, wherein a cooling-down period is transmitted as an instruction for action after the temperature rise.

6. The method of claim 1, wherein it is transmitted to the user as an instruction for action that the user shall set or change a distance between the product to be cooked and the heating device.

7. The method of claim 1, wherein it is transmitted to the user as an instruction for action that the user shall set or change a heating temperature of the heating device.

8. The method of claim 1, wherein before supplying heat to the product to be cooked, a dimension of the product to be cooked is determined and stored desired temperatures are selected depending on the determined dimension of the product to be cooked.

9. A system for preparing a food or a beverage, the system comprising:
a food thermometer having two temperature sensors;
a heating device;
a control device to which actual temperatures measured by the food thermometer with the at least two temperature sensors can be transmitted, wherein the control device is configured to
control the heating device depending on transmitted actual temperatures by comparison with desired temperatures stored in a memory unit, and/or
transmit instructions for action to a user based on a comparison of transmitted actual temperatures with desired temperatures stored in a memory unit, and/or
store transmitted actual temperatures in a memory unit as desired temperatures depending on a product to be cooked.

10. The system of claim 9, wherein a first desired temperature profile for the one temperature sensor and/or a second desired temperature profile for the other temperature sensor is stored in the memory unit depending on the product to be cooked.

11. The system of claim 9, wherein a temperature profile stored in the memory unit comprises a temperature rise towards the end of the cooking time.

12. The system of claim 9, further comprising a display and/or a loudspeaker, wherein the control device is configured to output an instruction for action to the user graphically via the display and/or acoustically via the loudspeaker.

13. The system of claim 12, wherein the display is a display of a kitchen appliance or a mobile phone, and/or wherein the loudspeaker is a loudspeaker of a kitchen appliance or a mobile phone.

14. The system of claim 9, further comprising a food processor, wherein the food processor includes the control device.

15. The system of claim 14, wherein the food processor includes a recipe development device, wherein the recipe development device is configured to suggest, to a user, desired temperatures for the creation of a recipe.

16. The system of claim 9, wherein the control device is configured in such a way that after the end of a heat supply, a cooling time is transmitted as an instruction for action.

17. The method of claim 1, wherein the product to be cooked is a bread dough.

18. The method of claim 1, wherein after the end of the heat supply, a cooling time is transmitted as an instruction for action.

19. A method for preparing a bread, the method comprising:
inserting a food thermometer including two temperature sensors into a bread dough in such a way that one temperature sensor is located outside the bread dough and the other temperature sensor is located in the bread dough;
supplying heat to the bread dough, by means of a heating device,
transmitting, by the food thermometer, actual temperatures measured with the one or more temperature sensors to a control device;
controlling, by the control device, the heating device depending on transmitted actual temperatures by comparison with desired temperatures stored in a memory unit; and/or
transmitting, by the control device, at least one instruction for action based on a comparison of at least one transmitted actual temperature with at least one desired temperature stored in a memory unit; and/or
storing, by the control device, at least one transmitted actual temperature in a memory unit as a desired temperature depending on a bread dough,
wherein after the end of the heat supply, a cooling time is transmitted as an instruction for action.

20. The method of claim 19, wherein a temperature profile stored in the memory unit comprises a temperature rise towards the end of the cooking time.
